(19) United States
(12) Patent Application Publication
(10) Pub. No.: US 2026/0316856 A1
(43) Pub. Date: Oct. 15, 2026

(54) TAPERED CARRIER ROLLER AND TRACK ASSEMBLY

(71) Applicant: Caterpillar Inc., Peoria, IL (US)

(72) Inventors: Anvesh TIWARI, CHENNAI (TAMIL NADU) (IN); Martin Tagore Joseph XAVIER, Tamil nadu (IN)

(73) Assignee: Caterpillar Inc., Peoria, IL (US)

(21) Appl. No.: 19/178,325

(22) Filed: Apr. 14, 2025

(51) Int. Cl. B62D 55/14; B62D 55/20; B62D 55/21

(52) U.S. Cl. CPC B62D 55/14; B62D 55/202; B62D 55/21

(57) ABSTRACT

A carrier roller for a track link assembly includes a first end surface, a second end surface, opposite to the first end surface, a first outer portion adjacent to the first end surface, and a second outer portion. The carrier roller also includes a transition portion between the first outer portion and the second outer portion, a first tapered surface on the first outer portion that tapers in a direction towards the transition portion from the first end surface, and second tapered surface, adjacent to the second end surface, that tapers from the second end surface toward the transition portion.

### TECHNICAL FIELD

The present disclosure relates generally to a track link assembly, and, more particularly, to a tapered carrier roller for a track link assembly.

### BACKGROUND

Each track assembly of a track-type machine, such as a dozer, an excavator, or a skid-steer loader, includes a loop of interconnected track link assemblies and a series of track shoes, referred to as a track, that moves or rotates around a drive sprocket, an idler, and a roller assembly. The idler and roller assembly includes rollers, or cylindrical wheels, that support the weight of the machine, guide and support the track link assemblies, and are positioned within the loop of track link assemblies.

The rollers include a top carrier roller and bottom track rollers. The top carrier roller is located toward the top of the track assembly to support and guide the track link assemblies and prevent the track link assemblies from slipping off the track (also referred to as slippage), during operation of machines in side-slope applications. The bottom track rollers are located along the bottom of the track assembly to displace loads along the track. Roller assemblies typically include track rollers with differing structures in an alternating arrangement. These rollers may each have generally flat, cylindrical surfaces for contacting the track rollers. Some rollers contain outer flanges, inner flanges, or both, to prevent slippage of the track assembly. These flanges, and the use of structurally-dissimilar rollers, can introduce complexity, impose manufacturing limitations, and increase cost.

U.S. Pat. No. 10,710,653, issued on Jul. 14, 2020 (“the '653 patent”), describes a self-aligning idler wheel design for use with elastomeric tracks. The idler wheel design of the '653 patent has an outer diameter that is greater than an inside diameter of the wheel. This arrangement places tension on an elastomeric track when the track contacts the inside diameter of the idler wheel, the tension tending to reduce the likelihood of track misalignment. The idler wheels described in the '653 patent do not provide a track assembly having tapered rollers suitable for use with tapered track links.

The system and method of the present disclosure may solve one or more of the problems set forth above or other problems in the art. The scope of the current disclosure, however, is defined by the attached claims, and not by the ability to solve any specific problem.

### SUMMARY

In one aspect, a carrier roller for a track link assembly may include a first end surface, a second end surface, opposite to the first end surface, a first outer portion adjacent to the first end surface, and a second outer portion. The carrier roller may also include a transition portion between the first outer portion and the second outer portion, a first tapered surface on the first outer portion that tapers in a direction towards the transition portion from the first end surface, and second tapered surface, adjacent to the second end surface, that tapers from the second end surface toward the transition portion.

In another aspect, a track assembly may include a first track link including: a first end, a second end opposite to the first end, and a first track link tapered surface formed on the second end. The track assembly may also include a carrier roller including: a first outer face, a second outer face, and a first roller tapered surface between the first outer face and the second outer face, the first roller tapered surface being configured to contact the first track link tapered surface, a portion of the first roller tapered surface with an increased thickness being configured to contact a portion of the first track link tapered surface.

In yet another aspect, a track assembly for a machine may include a first track link having: a flat surface configured to be connected to a track shoe, a through hole extending through the flat surface, and a first track link tapered surface opposite to the flat surface. The track assembly may also include a second track link, a bushing between the first track link and the second track link, the bushing extending along a bushing axis, and a carrier roller including: a first outer face, a central portion, and a first roller tapered surface between the first outer face and the central portion, the first roller tapered surface forming an angle of about 4° to about 10° with the bushing axis, the first roller tapered surface being configured to contact the first track link tapered surface.

### BRIEF DESCRIPTION OF THE DRAWINGS

FIG. 1 is a perspective view of a dozer, as an example of a track-type machine, having track link assemblies, including tapered carrier rollers, in accordance with the present disclosure.

FIG. 2 is a perspective view of a tapered carrier roller, as part of a track assembly shown in FIG. 1.

FIG. 3 is a front schematic view of the tapered carrier roller of the track assembly of FIG. 1.

FIG. 4 is a cross-sectional view of the track assembly including multiple track links and a tapered carrier roller according to the carrier roller shown in FIGS. 2 and 3.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value.

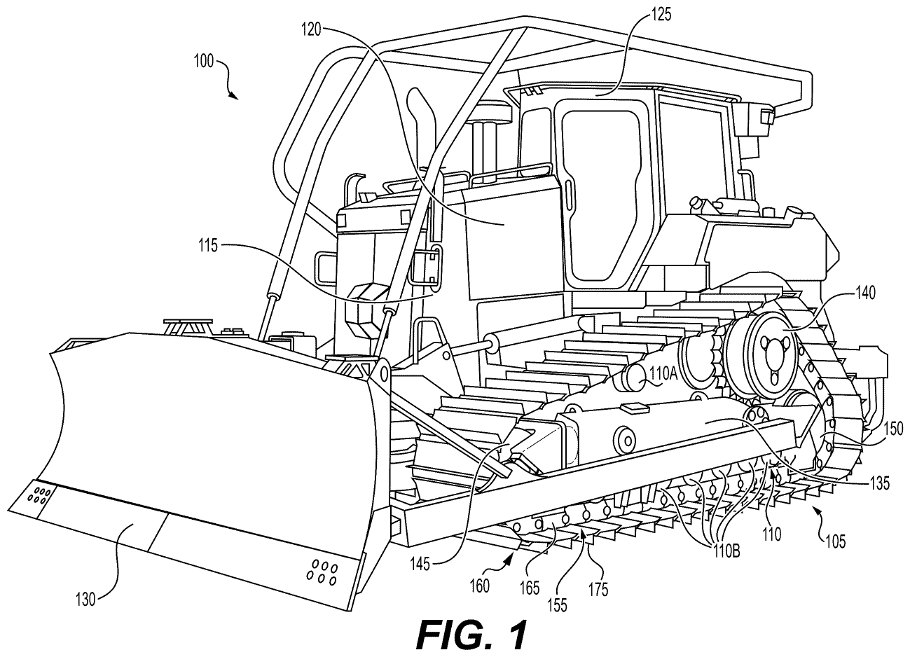

FIG. 1 shows a track-type machine 100 having two track assemblies 105 (only one shown), each track assembly 105 including one or a plurality of carrier rollers 110A, in accordance with the present disclosure. Machine 100 also includes a machine frame 115 supporting an engine 120 or other power-generating device (e.g., batteries, a fuel cell, a generator set, etc.), an operator station (or cab) 125, a work tool or implement in the form of a blade 130, and a track support frame 135 provided as part of an undercarriage of the machine frame 115.

Each track assembly 105 may include a drive sprocket 140, a front idler 145, a rear idler 150, track rollers 110, including at least one top carrier roller 110A and bottom track rollers 110B, and a plurality of track link assemblies 155 connected to a track 160. Track link assemblies 155 may form a loop around sprocket 140, front idler 145, rear idler 150, and track rollers 110. Front idler 145 and rear idler 150 may aid in movement of track 160, and help to maintain alignment of track 160 and to maintain proper tension of track 160. Top carrier roller 110A and bottom track rollers 110B support the weight of track 160 and help to maintain alignment of track 160. Bottom track rollers 110B also minimize strain on sprocket 140 and on idlers 145 and 150. Track assemblies 105, work tool 130, sprockets 140, idlers 145 and 150, and the plurality of track rollers 110 are all mounted to and supported by track support frame 135.

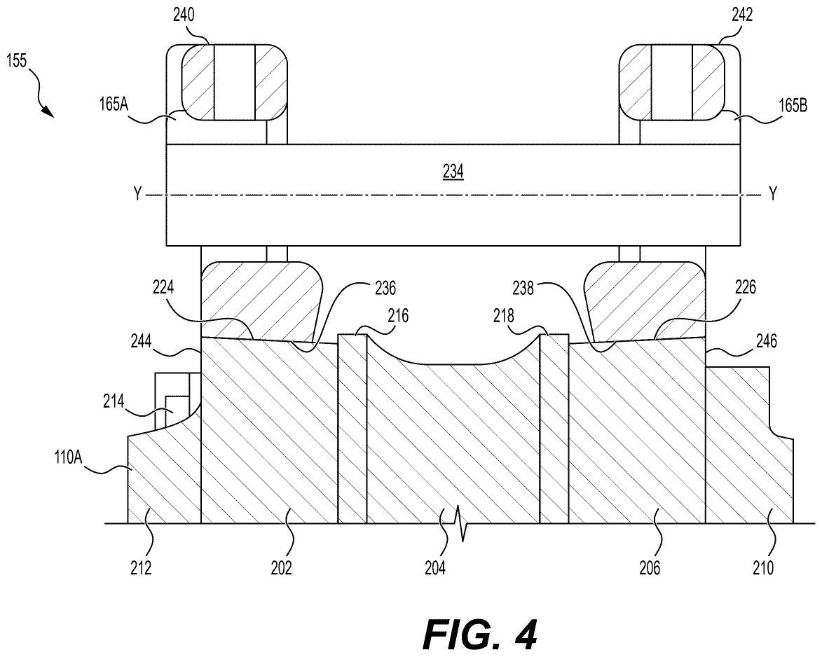

Each track link assembly 155 includes two laterally-opposed tapered track links 165, connected to each other and to adjacent pairs of tapered track links 165 using bushings 234 (FIG. 4) and link pins (not shown). Tapered track links 165 may be connected to track shoes 175 by bolts (not shown) and nuts (not shown) or other suitable fasteners to form track assemblies 105, assemblies 105 each including a respective track 160 formed by a series of track shoes 175. During operation, engine 120 is configured to generate a power output directed through a final drive (e.g., sprocket 140), which transmits a force to move track 160, including each track link assembly 155 and track shoe 175, around idlers 145 and 150 and rollers 110 to propel machine 100 forwards or backwards with engagement of track shoes 175 of a segment of the track 160 with ground material.

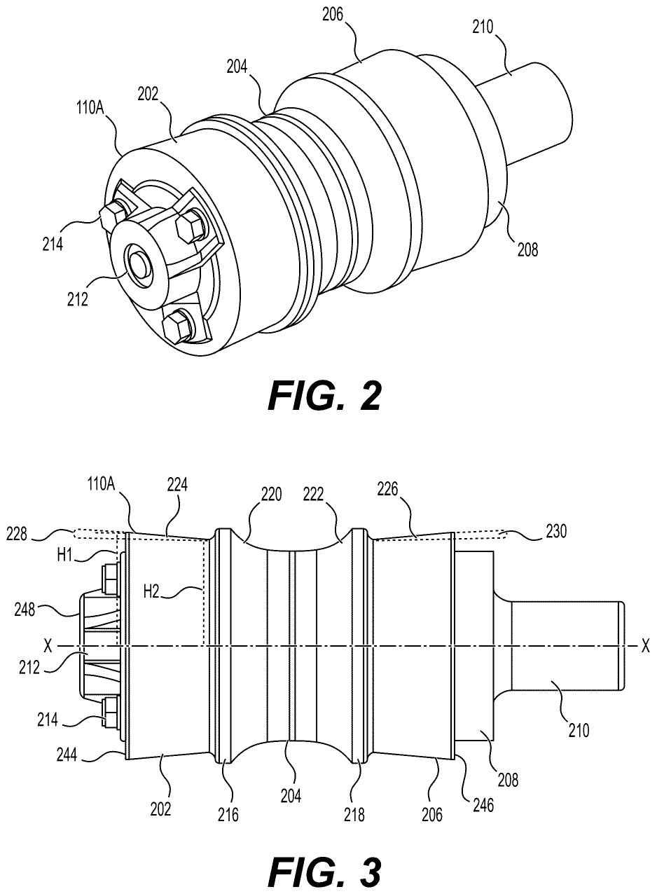

FIG. 2 is a perspective view of a tapered roller 110A, which may form part of a track assembly 105, in accordance with the present disclosure. As shown in FIG. 2, tapered roller 110A may include an outer contact portion 202, a bridge portion 204 (also referred to as a central portion), and an outer contact portion 206. As used herein, “outer,” “outside,” and “outward” refer to directions that face away from the midpoint of portions 202, 204, and 206 of roller 110A (e.g., a center of bridge portion 204).

A cover 212 forming an outermost end 248 of roller 110A may face laterally when assembled, on machine 100 and may be fastened with fasteners 214 at an outward end of tapered roller 110A to connect components of tapered roller 110A together and support internal components (e.g., internal shafts, bearings, seals, etc.). A shaft-side cover 208 may face in a direction opposite that of cover 212. Cover 208 may support a shaft 210 and, with outer cover 212, seal an interior of tapered roller 110A and support internal components of tapered roller 110A.

As shown in FIG. 3, outer contact portion 202 may include an outer tapered surface 224. Outer tapered surface 224 may extend between an outer face 244 of portion 202 and a first wall 216 at the intersection of bridge portion 204 and portion 202. Outer tapered surface 224 may taper, or narrow, in an inward direction from outer face 244 toward wall 216 (e.g., inwardly along axis X-X). Outer tapered surface 224 may therefore form an outward tapered end at outer face 244 and an inward tapered end that abuts first wall 216, the outward tapered end having a first height H1, the inward tapered end having a second height H2, as described below. As used herein, “inward,” “inner,” and “inside” refer to directions that face toward the midpoint of roller 110A.

Outer contact portion 206 may include an outer tapered surface 226. Outer tapered surface 226 may extend between an outer face 246 of portion 206 and a second wall 218, second wall 218 being formed at the intersection of bridge portion 204 and portion 206. Tapered surface 226 may taper from outer face 246 in an inward direction toward second wall 218.

In one or more embodiments, tapered roller 110A may be formed of two halves, or two half-rims, namely, a first half including transition portion 220 and outer contact portion 202, and a second half including outer contact portion 206, transition portion 222, and cover 208 to which shaft 210 is connected. The first half and the second half may be joined along bridge portion 204 via welding, for example. Other means of attaching or joining the first half and second half may be used. The first half and the second half include outer tapered surface 224 and tapered surface 226, respectively, with laterally-opposed surfaces of outer tapered surface 224 and tapered surface 226 being configured for contacting a track link 165.

In one or more embodiments, first wall 216 of tapered roller 110A may form a first flange on an inner end of the outer contact portion 202 nearest transition portion 220. Second wall 218 of tapered roller 110A may form a second flange on an end of outer contact portion 206 nearest transition portion 222. The first flange and the second flange may be cylindrical and each may be integrally formed with tapered roller 110A. In alternative embodiments, tapered roller 110A may include only a single flange contacting transition portion 204 (first wall 216 or second wall 218), or no flanges. In other embodiments, more than one flange may be provided on one or both of: the outer end of outer contact portion 202 at outer face 244, or the outer end of outer contact portion 206 at outer face 246. Further, as shown in the illustrated embodiment, roller 110A may free of flanges outside of surface 224 and free of flanges outside of surface 226.

As shown in FIG. 3, a width of outer contact portion 202 (e.g., from outer face 244 to first wall 216) and a width of outer contact portion 206 (e.g., from outer face 246 to second wall 218), both measured along a longitudinal axis X-X, are equal. A maximum height H1 of outer tapered surface 224 may be measured from axis X-X to an outer end of tapered surface 224. Height H1 may form a largest radial length defined by outer tapered surface 224, and may be equal to the maximum height or largest radius defined by tapered surface 226.

In one or more embodiments, the taper formed by each of outer tapered surface 224 and tapered surface 226 may extend linearly along their entireties. A first angle 228 of outer tapered surface 224 relative to axis X-X or a line parallel to axis X-X, as shown in FIG. 3, and a second angle 230 of inner tapered surface 226 relative to the axis X-X are equal. One or both of angles 228 and 230 may be about 2° to about 20° or about 4° to about 10°.

A minimum height H2 may form a smallest radius of outer tapered surface 224. Height H2 may be measured from axis X-X to an inner end of outer tapered surface 224. In some aspects, tapered surface 226 may have the same minimum height as height H2 of outer tapered surface 224.

In embodiments, one or more of the following may apply: the width of outer contact portion 202 and the width of outer contact portion 206 may be different from each other, first angle 228 and second angle 230 may be different from each other, or one or both of outer tapered surface 224 and tapered surface 226 may be non-linear, including being partially or entirely curved.

FIG. 4 is a cross-sectional view showing track link assembly 155, including a pair of tapered track links 165 in contact with tapered roller 110A. As shown in FIG. 4, multiple tapered track links 165 may oppose each other for contacting opposite sides of tapered roller 110A (see FIG. 3). The view of FIG. 4 shows a first tapered track link 165A in contact with outer contact portion 202 and a second tapered track link 165B in contact with outer contact portion 206.

First tapered track link 165A may include a flat surface 240 that is configured for contacting a track shoe that is fastened to tapered track links 165. Flat surface 240 may be entirely flat, or may include curved or protruding portions. A tapered track link surface 236 may oppose flat surface 240. Tapered track link surface 236 may be configured to contact outer tapered surface 224 during operation of machine 100. In some aspects, tapered track link surface 236 may be angled with respect to flat surface 240, to a horizontal axis Y-Y defined by bushing 234, or to axis X-X (FIG. 3) of tapered roller 110A when tapered track link surface 236 is in contact with outer tapered surface 224. The taper of track link surface 236 may form a portion having an increased thickness that is configured to come into contact with tapered surface 224.

In some aspects, an angle of inclination formed by the taper of tapered track link surface 236, as measured in an outward direction, may be about 4° to about 10° and may have the same magnitude as first angle 228 (FIG. 3). In other aspects, the angle of inclination formed by tapered track link surface 236 may be greater than or less than first angle 228.

Second tapered track link 165B, including second tapered track link surface 238 and surface 242, may mirror the structure of first tapered track link 165A. Like first tapered track link 165A, second tapered track link 165B may taper in an outward direction along second tapered track link surface 238.

### INDUSTRIAL APPLICABILITY

The tapered roller 110A and track assembly 155 of the present disclosure can be used in track type machines 100, such as track type tractors, dozers, excavators, and skid-steer loaders. Specifically, tapered track link 165 and track link assembly 155, in accordance with the present disclosure, can be used to form two track assemblies 105 connected to respective tracks 160 for propulsion of machine 100.

During operation of machine 100, track assembly 105, including a series of serially-connected track link assemblies 155, may be driven by sprocket 140 to propel machine 100 in a forward direction, in a reverse direction, and to turn to the left or to the right. Each track 160 may travel along rollers 110A and rollers 110B, with tapered surfaces of track links 165 contacting and moving along tapered surfaces of rollers 110A and 110B, as well as tapered surfaces of sprocket 140 and front idler 145.

The disclosed tapered roller 110A, track link assembly 155, and track assembly 105 may facilitate self-aligning functions of track assembly 105. In some aspects, the tapered surfaces of tapered roller 110A may prevent track slippage, including slippage when machine 100 is traveling laterally along a sloped surface. The self-aligning configuration of tapered roller 110A and track links 165 may facilitate the removal of flanges on track rollers, carrier rollers, or all rollers of track assembly 105, including flanges outside of outer tapered surface 224, flanges outside of tapered surface 226, flanges outside of tapered track link surface 236, or flanges outside of tapered track link surface 238. This may reduce manufacturing cost and allow for use of a single roller design such that all rollers (track rollers and carrier rollers) are identical to each other, reducing costs and facilitating precision forging or other manufacturing techniques for the rollers or other components of track assembly 105.

It will be apparent to those skilled in the art that various modifications and variations can be made to the disclosed tapered carrier roller and track link assembly, and method of manufacture, without departing from the scope of the disclosure. Other embodiments of the tapered carrier roller and track link assembly will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

What is claimed is:

1. A carrier roller for a track link assembly, the carrier roller comprising:
a first end surface;
a second end surface, opposite to the first end surface;
a first outer portion adjacent to the first end surface;
a second outer portion;
a transition portion between the first outer portion and the second outer portion;
a first tapered surface on the first outer portion that tapers in a direction towards the transition portion from the first end surface; and
a second tapered surface, adjacent to the second end surface, that tapers from the second end surface toward the transition portion.

2. The carrier roller of claim 1, wherein the first tapered surface is a flat surface with a constant angle of inclination.

3. The carrier roller of claim 1, wherein the first tapered surface forms an angle of inclination with a horizontal axis about which the carrier roller is configured to rotate, the angle of inclination being from about 2° to about 20°.

4. The carrier roller of claim 1, wherein the first tapered surface forms an angle of inclination with a horizontal axis about which the carrier roller is configured to rotate, the angle of inclination being from about 4° to about 10°.

5. The carrier roller of claim 1, wherein the first tapered surface includes an outward tapered end and an inward tapered end, the inward tapered end having a smaller height as compared to a height of the outward tapered end.

6. The carrier roller of claim 5, wherein an angle of inclination of the inward tapered end is the same as an angle of inclination of the outward tapered end.

7. The carrier roller of claim 1, wherein the transition portion connects an outer wall connected at an end of the first tapered surface to an inner wall connected at an end of the second tapered surface.

8. A track assembly, comprising:
a first track link including:
a first end;
a second end opposite to the first end; and
a first track link tapered surface formed on the second end; and
a carrier roller including:
a first outer face;
a second outer face; and
a first roller tapered surface between the first outer face and the second outer face, the first roller tapered surface being configured to contact the first track link tapered surface,
a portion of the first roller tapered surface with an increased thickness being configured to contact a portion of the first track link tapered surface.

9. The track assembly of claim 8, further including:
a second track link connected to the first track link, the second track link including a second track link tapered surface that tapers in an outward direction of the second track link; and
a second roller tapered surface between the first outer face and the second outer face of the carrier roller, the second track link tapered surface being configured to contact the second roller tapered surface when the first track link tapered surface contacts the first roller tapered surface.

10. The track assembly of claim 9, wherein a taper of the first roller tapered surface and a taper of the second roller tapered surface extend linearly.

11. The track assembly of claim 9, wherein the first roller tapered surface forms a first angle with a horizontal axis about which the carrier roller is configured to rotate and the second roller tapered surface forms a second angle with the horizontal axis, the first angle being substantially equal to the second angle.

12. The track assembly of claim 11, wherein the first angle and the second angle are within a range of about 4° to about 10°.

13. The track assembly of claim 9, wherein the first roller tapered surface forms a first angle with a horizontal axis about which the carrier roller is configured to rotate and the second roller tapered surface forms a second angle with the horizontal axis, the first angle being different than the second angle.

14. The track assembly of claim 9, further including a central portion of the carrier roller that is positioned between the first track link tapered surface and the second track link tapered surface when the first track link is in contact with the carrier roller.

15. A track assembly for a machine, the track assembly comprising:
a first track link having:
a flat surface configured to be connected to a track shoe;
a through hole extending through the flat surface; and
a first track link tapered surface opposite to the flat surface;
a second track link;
a bushing between the first track link and the second track link, the bushing extending along a bushing axis; and
a carrier roller including:
a first outer face;
a central portion; and
a first roller tapered surface between the first outer face and the central portion, the first roller tapered surface forming an angle of about 4° to about 10° with the bushing axis, the first roller tapered surface being configured to contact the first track link tapered surface.

16. The track assembly of claim 15, wherein the second track link includes a second track link tapered surface that opposes the first track link tapered surface in a horizontal direction parallel to the bushing axis, the second track link tapered surface being inclined in a direction that is transverse to a direction of inclination of the first track link tapered surface.

17. The track assembly of claim 15, wherein the first roller tapered surface tapers uniformly along an entirety of the first roller tapered surface.

18. The track assembly of claim 15, further including a second roller tapered surface between a second outer face and the central portion, the first roller tapered surface forming an angle of about 4° to about 10° with the bushing axis, the second roller tapered surface being configured to contact a second track link tapered surface of the second track link.

19. The track assembly of claim 15, wherein the carrier roller is free of flanges located between the first outer face and an in inward end of the first track link tapered surface.

20. The track assembly of claim 15, wherein the carrier roller is free of flanges located outward of an inward end of the second track link tapered surface.
